(19) United States
(12) Patent Application Publication
(10) Pub. No.: US 2026/0162899 A1
(43) Pub. Date: Jun. 11, 2026

(54) MULTILAYER CERAMIC ELECTRONIC COMPONENT

(71) Applicant: SAMSUNG ELECTRO-MECHANICS CO., LTD., Suwon-si (KR)

(72) Inventors: Dongjoo Shin, Suwon-si (KR); Shinae Ryu, Suwon-si (KR); Taehee Han, Suwon-si (KR)

(73) Assignee: SAMSUNG ELECTRO-MECHANICS CO., LTD., Suwon-si (KR)

(21) Appl. No.: 19/274,357

(22) Filed: Jul. 18, 2025

(30) Foreign Application Priority Data
Dec. 6, 2024 (KR) 10-2024-0180982

(51) Int. Cl. H01G 4/224; H01G 4/258; H01G 4/30

(52) U.S. Cl. CPC H01G 4/224; H01G 4/258; H01G 4/30

(57) ABSTRACT

A multilayer ceramic electronic component includes a ceramic body having a plurality of dielectric layers and a plurality of internal electrodes disposed with the dielectric layers interposed therebetween. An external electrode is disposed on the outside of the ceramic body. A coating layer is formed on at least a portion of an outer surface of the ceramic body and includes a water-repellent coating agent and at least one of a heat stabilizer that removes free radicals generated from the water-repellent coating agent, and an antioxidant that decomposes a free radical forming factor. The coating layer improves moisture resistance reliability and durability of the component during thermal and environmental stress.

### CROSS-REFERENCE TO RELATED APPLICATION

This application claims priority to and the benefit of Korean Patent Application No. 10-2024-0180982 filed with the Korean Intellectual Property Office on Dec. 6, 2024, the entire contents of which are incorporated herein by reference.

### BACKGROUND OF THE INVENTION

### (a) Field of the Invention

The present disclosure relates to a multilayer ceramic electronic component.

### (b) Description of the Related Art

Electronic components using ceramic materials include capacitors, inductors, piezoelectric components, varistors, or thermistors. Among these ceramic electronic components, multilayer ceramic capacitors (MLCCs) may be used in various electronic devices due to their small size, high capacitance, and ease of mounting.

Multilayer ceramic capacitors are electronic components in the form of a chip that are mounted on a substrate of various electronic products, such as an image device such as liquid crystal display (LCD), plasma display panel (PDP), an organic light emitting diode (OLED), a computer, a personal portable terminal and a smart phone, to charge and discharge electricity.

As the usage environments of multilayer ceramic capacitors become more diverse, the moisture resistance reliability of multilayer ceramic capacitors is considered important.

Multilayer ceramic capacitors may include internal electrodes disposed inside a ceramic body and external electrodes disposed outside the ceramic body and connected to the internal electrodes. As a method of increasing the effective capacity in order to miniaturize and increase the capacity of multilayer ceramic capacitors, a method of increasing the size of the ceramic body and minimizing the thickness of the external electrodes can be sought.

However, as the thickness of the external electrodes becomes thinner to increase the size of the ceramic body, the moisture resistance reliability of multilayer ceramic capacitors may decrease. In addition, during the plating process of external electrodes, permeation of a plating solution can induce defects in external electrode terminals and the internal structure of the ceramic body, which may lead to degradation of the reliability of the final product, especially the deterioration of characteristics and failure during high temperature and high pressure operation.

### SUMMARY OF THE INVENTION

An aspect of embodiments is to provide multilayer ceramic electronic components that can secure moisture resistance reliability while achieving miniaturization and high capacity.

However, the problem to be solved by the embodiments of the present disclosure is not limited to the above-described problems and can be variously extended within the scope of the technical concept included in the present disclosure.

A multilayer ceramic electronic component according to an embodiment may include a ceramic body comprising a plurality of dielectric layers, and a plurality of internal electrodes disposed with the dielectric layers interposed therebetween, an external electrode disposed outside the ceramic body, and a coating layer disposed on at least a portion of an outer surface of the ceramic body. The coating layer may include a water-repellent coating agent, and at least one of a heat stabilizer removing a free radical generated from the water-repellent coating agent and an antioxidant breaking down a free radical forming factor.

The coating layer may include a first layer comprising the heat stabilizer, the antioxidant, and the water-repellent coating agent, and a second layer disposed on the first layer and comprising the water-repellent coating agent.

The coating layer may include a first layer comprising the heat stabilizer, the antioxidant, and the water-repellent coating agent, a second layer disposed on the first layer and comprising the heat stabilizer, a third layer disposed on the second layer and comprising the antioxidant, and a fourth layer disposed on the third layer and comprising the water-repellent coating agent.

The coating layer may include a first layer comprising the heat stabilizer, a second layer disposed on the first layer and comprising the antioxidant, and a third layer disposed on the second layer and comprising the water-repellent coating agent.

The coating layer may include a first layer comprising the antioxidant, a second layer disposed on the first layer and comprising the heat stabilizer, and a third layer disposed on the second layer and comprising the water-repellent coating agent.

The coating layer may include a first layer comprising the heat stabilizer, and a second layer disposed on the first layer and comprising the water-repellent coating agent.

The coating layer may be disposed on a portion of the outer surface of the ceramic body except for a portion where the external electrode is disposed.

At least one of the ceramic body and the external electrode may include a component of the coating layer

The water-repellent coating agent may include a fluorine-based compound comprising at least one of a silane-fluorine-based compound, perfluoropolyether (PFPE), polytetrafluoroethylene (PTFE), fluorinated ethylenepropylene (FEP), and polyvinylfluoride (PVF).

The heat stabilizer may include at least one selected from benzotriazole-based compound comprising hydroxyphenylbenzotriazole, sebacate-based compound comprising at least one of bis-(1,2,2,6,6-pentamethyl-4-piperidyl) sebacate, and bis-(1-octyl-2,2,6,6-tetramethyl-4-piperidyl) sebacate, and formamidine-based compound comprising at least one of N-(4-alkoxy carbonylphenyl)-N′-alkyl-N′-phenylformamidine, N-(4-methoxycarbonylphenyl)-N′-methyl-N′-phenylformamidine, N-(4-ethoxycarbonylphenyl)-N′-methyl-N′-phenylformamidine, and N-(4-ethoxycarbonylphenyl)-N′-ethyl-N′-phenyl formamidine.

The antioxidant may include at least one selected from phosphorus-based compound comprising phosphite-based compound, and phenol-based compound comprising at least one of methylhydrocinnamate, benzenepropionic acid, tetrakis [methylene-3 (3′5′-di-tert-butyl-4′-hydroxyphenyl) propionate]methane, and triethyleneglycolbis(3-tert-butyl-4-hydroxy-5-methylphenyl) propionate.

A multilayer ceramic electronic component according to another embodiment may include a ceramic body comprising a plurality of dielectric layers, and a plurality of internal electrodes disposed with the dielectric layers interposed therebetween, an external electrode disposed outside the ceramic body, and a coating layer disposed on at least a portion of an outer surface of the ceramic body. The coating layer may include fluorine-based compound, and at least one of benzotriazole-based compound, sebacate-based compound, formamidine-based compound, phenol-based compound, and phosphorus-based compound.

The coating layer may include a first layer comprising at least one of the benzotriazole-based compound, the sebacate-based compound, and the formamidine-based compound, at least one of the phenol-based compound, and the phosphorus-based compound, and the fluorine-based compound, and a second layer disposed on the first layer and comprising the fluorine-based compound.

The coating layer may include a first layer comprising at least one of the benzotriazole-based compound, the sebacate-based compound, and the formamidine-based compound, at least one of the phenol-based compound, and the phosphorus-based compound, and the fluorine-based compound, a second layer disposed on the first layer and comprising at least one of the benzotriazole-based compound, the sebacate-based compound, and the formamidine-based compound, a third layer disposed on the second layer and comprising at least one of the phenol-based compound, and the phosphorus-based compound, and a fourth layer disposed on the third layer and comprising the fluorine-based compound.

The coating layer may include a first layer comprising at least one of the benzotriazole-based compound, the sebacate-based compound, and the formamidine-based compound, a second layer disposed on the first layer and comprising at least one of the phenol-based compound, and the phosphorus-based compound, and a third layer disposed on the second layer and comprising the fluorine-based compound.

The coating layer may include a first layer comprising at least one of the phenol-based compound, and the phosphorus-based compound, a second layer disposed on the first layer and comprising at least one of the benzotriazole-based compound, the sebacate-based compound, and the formamidine-based compound, and a third layer disposed on the second layer and comprising the fluorine-based compound.

The coating layer may include a first layer comprising at least one of the benzotriazole-based compound, the sebacate-based compound, and the formamidine-based compound, and a second layer disposed on the first layer and comprising the fluorine-based compound.

The benzotriazole-based compound may include hydroxyphenyl benzotriazole, the sebacate-based compound may include at least one of bis-(1,2,2,6,6-pentamethyl-4-piperidyl) sebacate, and bis-(1-octyl-2,2,6,6-tetramethyl-4-piperidyl) sebacate, the formamidine-based compound may include at least one of N-(4-alkoxycarbonylphenyl)-N′-alkyl-N′-phenylformamidine, N-(4-methoxycarbonyl phenyl)-N′-methyl-N′-phenylformamidine, N-(4-ethoxycarbonylphenyl)-N′-methyl-N′-phenylformamidine, and N-(4-ethoxycarbonylphenyl)-N′-ethyl-N′-phenyl formamidine, and the fluorine-based compound may include at least one of silane-fluorine-based compound, polytetrafluoroethylene (PTFE), perfluoropolyether (PFPE), fluorinatedethylenepropylene (FEP), and polyvinylfluoride (PVF).

The phenol-based compound may include at least one of methyl hydrocinnamate, benzenepropionic acid, tetrakis [methylene-3 (3′5′-di-tert-butyl-4′-hydroxyphenyl) propionate]methane, and triethyleneglycolbis(3-tert-butyl-4-hydroxy-5-methylphenyl) propionate, and the phosphorus-based compound comprises phosphite-based compound.

At least one of the ceramic body and the external electrode may include a component of the coating layer.

According to the embodiments of the multilayer ceramic electronic component, the effective capacity of the multilayer ceramic electronic component can be increased, and the moisture resistance of the multilayer ceramic electronic component can be improved by preventing the permeation of the plating solution during the plating process

However, it is obvious that the effects of the embodiments are not limited to the above-described effects, and may be variously extended without departing from the concept and scope of the present disclosure.

### BRIEF DESCRIPTION OF THE DRAWINGS

FIG. 1 is a perspective view schematically showing a multilayer ceramic electronic component according to an embodiment.

FIG. 2 is an exploded perspective view showing a stacking structure of an internal electrode in the multilayer ceramic electronic component of FIG. 1.

FIG. 3 is a cross-sectional view taken along the line II-II′ of FIG. 1.

FIGS. 4A to 4C are cross-sectional views of manufacturing steps of a multilayer ceramic electronic component according to an embodiment.

FIG. 5 is a cross-sectional view showing a multilayer ceramic electronic component according to another embodiment.

FIG. 6 is a cross-sectional view showing a multilayer ceramic electronic component according to yet another embodiment.

FIG. 7 is a graph of water-repellent coating performance of multilayer ceramic electronic components according to an embodiment and a comparative example.

FIG. 8 is a graph of water-repellent coating performance of a multilayer ceramic electronic component according to another embodiment.

FIG. 9 is a graph of water-repellent coating performance of a multilayer ceramic electronic component according to yet another embodiment.

### DETAILED DESCRIPTION OF THE EMBODIMENTS

Hereinafter, various embodiments of the present disclosure will be described in detail so that a person of ordinary skill in the technical field to which the present disclosure belongs can easily implement it with reference to the accompanying drawings. In order to clearly describe the present disclosure, parts unrelated to the description are omitted in the drawings, and the same reference numerals are designated to the same or similar elements throughout the specification. In addition, some components in the drawings may be exaggerated, omitted, or schematically illustrated, and the size of each component may not entirely reflect the actual size.

The accompanying drawings are provided only in order to allow embodiments disclosed in the present specification to be easily understood and are not to be interpreted as limiting the concept disclosed in the present specification, and it is to be understood that the present disclosure includes all modifications, equivalents, and substitutions without departing from the scope and concept of the present disclosure.

Terms including ordinal numbers such as first, second, and the like will be used only to describe various components and are not to be interpreted as limiting these components. The terms are only used to differentiate one component from other components.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

It will be further understood that terms “comprises/includes” or “have” used throughout the specification specify the presence of stated features, numerals, steps, operations, components, parts, or a combination thereof, but do not preclude the presence or addition of one or more other features, numerals, steps, operations, components, parts, or a combination thereof. Accordingly, unless explicitly described to the contrary, the word “comprise” and variations such as “comprises” or “comprising” will be understood to imply the inclusion of stated components but not the exclusion of any other components.

Further, throughout the specification, the phrase “in a plan view” means when an object portion is viewed from above, and the phrase “in a cross-sectional view” means when a cross-section taken by vertically cutting an object portion is viewed from the side. In addition, throughout the specification, “connected” means that two or more components are not only directly connected, but two or more components may be connected indirectly through other components, physically connected as well as being electrically connected, or it may be referred to by different names depending on the location or function but may mean integral.

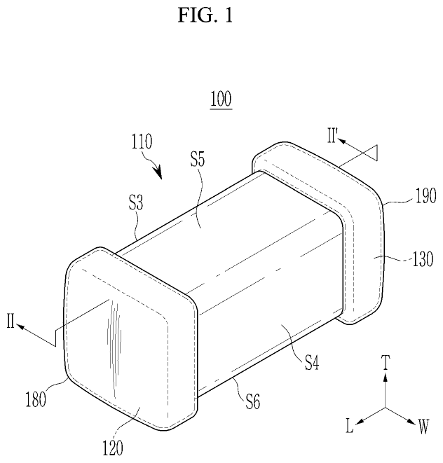

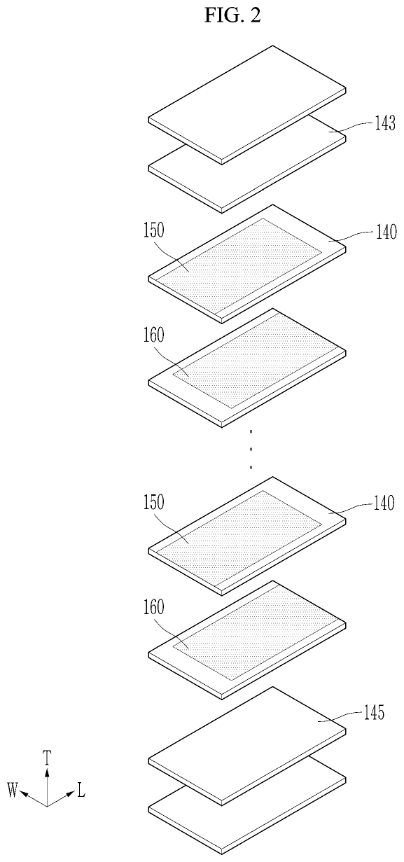

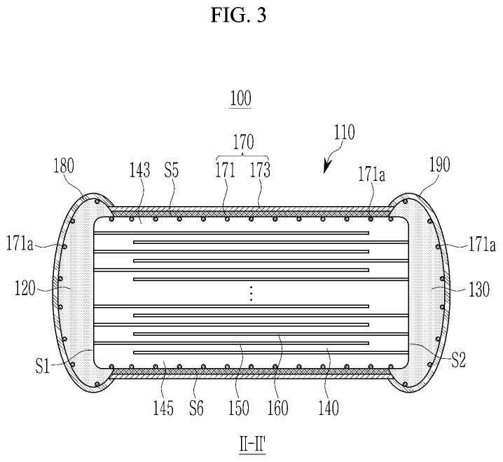

FIG. 1 is a perspective view schematically showing a multilayer ceramic electronic component according to an embodiment. FIG. 2 is an exploded perspective view showing a stacking structure of an internal electrode in the multilayer ceramic electronic component of FIG. 1. FIG. 3 is a cross-sectional view taken along the line II-II′ of FIG. 1.

Referring to FIGS. 1 to 3, a multilayer ceramic electronic component 100 according to the present embodiment includes ceramic body 110, a first external electrode 120, a second external electrode 130, a plurality of first internal electrodes 150, and a plurality of second internal electrodes 160.

First, when directions are defined to clearly describe the present embodiment, L-axis, W-axis, and T-axis shown in the drawings indicate axes indicating a length direction, a width direction, and a thickness direction of the multilayer ceramic electronic component 100, respectively.

The thickness direction (T-axis direction) may be a direction perpendicular to a wide surface (major surface) of sheet-like elements. For example, the thickness direction (T-axis direction) may be used as the same meaning as the direction in which dielectric layers 140 are stacked.

The length direction (L-axis direction) may be a direction parallel to the wide surfaces (main surfaces) of the sheet-like elements and may be a direction that intersects (or is orthogonal to) the thickness direction (T-axis direction). For example, the length direction (L-axis direction) may be a direction in which the first external electrode 120 and the second external electrode 130 face each other.

The width direction (W-axis direction) may be a direction parallel to the wide surface (main surface) of the sheet-like elements and may be a direction that simultaneously intersects (or is orthogonal to) the thickness direction (T-axis direction) and the length direction (L-axis direction).

The ceramic body 110 may have a substantially hexahedral shape, but the present embodiment is not limited thereto. Due to contraction during sintering, the ceramic body 110 may have a substantially hexahedral shape, although not a perfect hexahedral shape. For example, the ceramic body 110 has a substantially rectangular hexahedral shape, but corner or vertex portions may have a rounded shape.

In the present embodiment, for convenience of description, surfaces facing each other in the length direction (L-axis direction) may be defined as a first surface S1 and a second surface S2, surfaces facing each other in the width direction (W-axis direction) and connecting the first surface S1 and the second surface S2 may be defined as a third surface S3 and a fourth surface S4, and surfaces facing each other in the thickness direction (T-axis direction) and connecting the first surface S1 and the second surface S2 may be defined as a fifth surface S5 and a sixth surface S6.

Therefore, a first direction, which is a direction in which the first surface S1 and the second surface S2 face each other, may be the length direction (L-axis direction), and a second direction and a third direction that are perpendicular to the first direction and perpendicular to each other may be the thickness direction (T-axis direction) and the width direction (W-axis direction), respectively, or the width direction (W-axis direction) and the thickness direction (T-axis direction), respectively.

A length of the ceramic body 110 may mean, based on an optical microscope or scanning electron microscope (SEM) photograph of a cross-section in the length direction (L-axis direction)—the thickness direction (T-axis direction) at a center of the width direction (W-axis direction) of the ceramic body 110, a maximum value of lengths of a plurality of line segments that connect two outermost boundary lines facing each other in the length direction (L-axis direction) of the ceramic body 110 shown in the above cross-sectional photograph and are parallel to the length direction (L-axis direction). Meanwhile, the length of the ceramic body 110 may mean a minimum value of lengths of a plurality of line segments that connect two outermost boundary lines facing each other in the length direction (L-axis direction) of the ceramic body 110 shown in the above-mentioned cross-section photograph and are parallel to the length direction (L-axis direction), respectively. Alternatively, the length of the ceramic body 110 may mean an arithmetic average value of lengths of at least two of a plurality of line segments that connect two outermost boundary lines facing each other in the length direction (L-axis direction) of the ceramic body 110 shown in the above cross-sectional photograph and are parallel to the length direction (L-axis direction).

A thickness of the ceramic body 110 may mean, based on an optical microscope or scanning electron microscope (SEM) photograph of a cross-section in the length direction (L-axis direction)—the thickness direction (T-axis direction) at a center of the width direction (W-axis direction) of the ceramic body 110, a maximum value of lengths of a plurality of line segments that connect two outermost boundary lines facing each other in the thickness direction (T-axis direction) of the ceramic body 110 shown in the above cross-sectional photograph and are parallel to the thickness direction (T-axis direction). Meanwhile, the thickness of the ceramic body 110 may mean a minimum value of lengths of a plurality of line segments that connect two outermost boundary lines facing each other in the thickness direction (T-axis direction) of the ceramic body 110 shown in the above-mentioned cross-section photograph and are parallel to the thickness direction (T-axis direction), respectively. On the other hand, the thickness of the ceramic body 110 may mean an arithmetic average value of lengths of at least two line segments among a plurality of line segments that connect two outermost boundary lines facing each other in the thickness direction (T-axis direction) of the ceramic body 110 shown in the above-mentioned cross-section photograph and parallel to the thickness direction (T-axis direction), respectively.

A width of the ceramic body 110 may mean, based on an optical microscope or scanning electron microscope (SEM) photograph of a cross-section in the length direction (L-axis direction)—the width direction (W-axis direction) at a center of the thickness direction (T-axis direction) of the ceramic body 110, a maximum value of lengths of a plurality of line segments that connect two outermost boundary lines facing each other in the width direction (W-axis direction) of the ceramic body 110 shown in the above cross-sectional photograph and are parallel to the width direction (W-axis direction).

Meanwhile, the width of the ceramic body 110 may mean a minimum value of lengths a plurality of line segments that connect two outermost boundary lines facing each other in the width direction (W-axis direction) of the ceramic body 110 shown in the above-mentioned cross-section photograph and are parallel to the width direction (W-axis direction), respectively. On the other hand, the width of the ceramic body 110 may mean an arithmetic average value of lengths of at least two line segments among a plurality of line segments that connect two outermost boundary lines facing each other in the width direction (W-axis direction) of the ceramic body 110 shown in the above-mentioned cross-section photograph and are parallel to the width direction (W-axis direction), respectively.

The ceramic body 110 may include a plurality of dielectric layers 140 stacked in the thickness direction (T-axis direction). A boundary between the dielectric layers 140 may be unclear. For example, boundaries between the dielectric layers 140 are difficult to see without using a scanning electron microscope (SEM), and multiple dielectric layers 140 may appear as a single structure.

The first internal electrode 150 and the second internal electrode 160 may be alternately stacked interposing the dielectric layer 140. This stacked structure may be repeated within the ceramic body 110, the internal electrode closest to the fifth surface S5 of the ceramic body 110 may be the first internal electrode 150 or the second internal electrode 160 and the internal electrode closest to the sixth surface S6 may be the first internal electrode 150 or the second internal electrode 160.

The first internal electrode 150 and the second internal electrode 160 have different polarities, and may be electrically insulated from each other by the dielectric layer 140 disposed therebetween.

The first internal electrode 150 and the second internal electrode 160 may be disposed to be offset from each other in the length direction (L-axis direction) interposing the dielectric layer 140. A side end portion of the first internal electrode 150 may be exposed through the first surface S1 of the ceramic body 110, and a side end portion of the second internal electrode 160 may be exposed through the second surface S2 of the ceramic body 110. The end portion of the first internal electrode 150 exposed from the first surface S1 of the ceramic body 110 may be connected to the first external electrode 120. The end portion of the second internal electrode 160 exposed from the second surface S2 of the ceramic body 110 may be connected to the second external electrode 130.

The first internal electrode 150 and the second internal electrode 160 may be formed by printing a conductive paste containing a conductive metal on a surface of the dielectric layer 140. For example, internal electrodes may be formed by printing a conductive paste containing nickel (Ni) or a nickel (Ni) alloy on the surface of the dielectric layer by screen printing or gravure printing. However, the present embodiment is not limited thereto.

For example, an average thickness of the first internal electrode 150 and the second internal electrode 160 may be generally 0.1 μm or more and 2 μm or less.

Here, the thickness of the internal electrode may mean an average thickness of one internal electrode disposed between two dielectric layers. Based on scanning electron microscope (SEM) photograph of magnification of 10,000 times with respect to the length direction (L-axis direction)—the thickness direction (T-axis direction) cross-section at the central portion of the ceramic body 110 in the width direction (W-axis direction), the average thickness of the internal electrode may be an arithmetic average value of values obtained by measuring thicknesses of one internal electrode shown in above-mentioned cross-sectional photograph at 30 points having uniform interval in the length direction (L-axis direction). The above-mentioned 30 points may be designated in an active region described later. By measuring the average thickness of each of the 10 internal electrodes in this way and then deriving the arithmetic average of the measured values, the average thickness of the internal electrodes may be further generalized.

When a voltage is applied to the first external electrode 120 and the second external electrode 130, charges are accumulated between the first internal electrode 150 and the second internal electrode 160 that face each other. That is, a capacitance may be obtained between the first internal electrode 150 electrically connected to the first external electrode 120 and the second internal electrode 160 electrically connected to the second external electrode 130. A capacitance of the multilayer ceramic electronic component 100 is proportional to an overlapping area of the first internal electrode 150 and the second internal electrode 160 overlapping each other along the thickness direction (T-axis direction).

In other words, the multilayer ceramic electronic component 100 may include an active region and a margin region. The active region may refer to a region where the first internal electrode 150 and the second internal electrode 160 overlap along the thickness direction (T-axis direction), and the margin region may refer to a region between the first surface S1 of the ceramic body 110 and the active region and a region between the second surface S2 of the ceramic body 110 and the active region.

The multilayer ceramic electronic component 100 is classified based on its length and width. Therefore, even in multilayer ceramic electronic components having the same length or width, the size of the ceramic body may vary according to the thickness of the external electrode. That is, a multilayer ceramic electronic component having a thinner external electrode may have a larger ceramic body than a multilayer ceramic electronic component having a thicker external electrode. If the ceramic body is larger, it may mean that the above-described active area is larger, and furthermore, capacitance may be larger. As a result, capacitance may increase as the external electrode of the multilayer ceramic electronic component becomes thinner. In the present embodiment, by forming a thin electrode layer on the first and second surfaces of the ceramic body, the thickness of the external electrode can be reduced, and a beneficial effect can be obtained accordingly.

A first cover layer 143 and a second cover layer 145 may be disposed outside of the active region in the thickness direction (T-axis direction).

The first cover layer 143 is disposed between the fifth surface S5 of the ceramic body 110 and the internal electrode closest thereto. The second cover layer 145 is disposed between the sixth surface S6 of the ceramic body 110 and the internal electrode closest thereto.

That is, in the ceramic body 110, the first cover layer 143 may be disposed above an uppermost internal electrode, and the second cover layer 145 may be disposed below a lowermost internal electrode. The first cover layer 143 and the second cover layer 145 may have the same composition as the dielectric layer 140. The first cover layer 143 and the second cover layer 145 may be formed by stacking one or more dielectric layers on each of an outer surface of an uppermost internal electrode and an outer surface of a lowermost internal electrode.

The first cover layer 143 and the second cover layer 145 may serve to prevent damage to the first internal electrode 150 and the second internal electrode 160 due to physical or chemical stress.

The dielectric layer 140 may include a ceramic material having a high permittivity. For example, the ceramic material may include a dielectric ceramic including components such as BaTiO3, CaTiO3, SrTiO3, or CaZrO3. In addition, an auxiliary component, such as a manganese (Mn) compound, an iron (Fe) compound, a chromium (Cr) compound, a cobalt (Co) compound, and a nickel (Ni) compound may be further included to these components. For example, the dielectric layer may be (Ba₁₋ₓCaₓ)TiO₃, Ba(Ti_{1-y}Ca_{y})O₃, (Ba₁₋ₓCaₓ)(Ti_{1-y}Zr_{y})O₃, Ba(Ti_{1-y}Zr_{y})O₃, @@@ or the like, in which calcium (Ca), zirconium (Zr), or the like is partially dissolved in BaTiO₃, the present disclosure is not limited thereto.

In addition, at least one of a ceramic additive, an organic solvent, a plasticizer, a binder, and a dispersant may be further included in the dielectric layer 140. The ceramic additive may be, for example, a transition metal oxide or carbide, a rare earth element, magnesium (Mg), aluminum (Al), and the like.

For example, the average thickness of the dielectric layer 140 may be 0.1 μm to 10 μm, but the present embodiment is not limited thereto.

The first external electrode 120 and the second external electrode 130 may be provided with voltages having different polarities and may be electrically connected to exposed portions of the first internal electrode 150 and the second internal electrode 160, respectively.

The first external electrode 120 and the second external electrode 130 are disposed outside the ceramic body 110. The first external electrode 120 and the second external electrode 130 may be disposed on both sides of the ceramic body 110 in the first direction.

The first external electrode 120 may be disposed on the first surface S1 of the ceramic body 110 and may extend to a portion of at least one surface of the third surface S3, the fourth surface S4, the fifth surface S5, and the sixth surface S6. The second external electrode 130 may be disposed on the second surface S2 of the ceramic body 110 and may extend to a portion of at least one surface of the third surface S3, the fourth surface S4, the fifth surface S5, and the sixth surface S6.

The first external electrode 120 and the second external electrode 130 may include a connection portion and a band portion. The connection portion may be disposed on the first surface S1 or the second surface S2 of the ceramic body 110, and connected to an exposed portion of the first internal electrode 150 or the second internal electrode 160. The band portion may include a portion extending from the connection portion to at least one of the third surface S3, the fourth surface S4, the fifth surface S5, and the sixth surface S6 of the ceramic body 110.

The first external electrode 120 and the second external electrode 130 may include at least one of conductive metals such as copper (Cu), silver (Ag), or nickel (Ni), and may further include glass and epoxy, or the like. The first external electrode 120 and the second external electrode 130 may be formed by applying and sintering a conductive paste including a metal.

Meanwhile, the multilayer ceramic electronic component 100 may further include a first plating layer 180 and a second plating layer 190.

The first plating layer 180 covers the first external electrode 120. The first plating layer 180 may include a first layer for securing mechanical, electrical, and chemical stability of external electrodes, and a second layer made of a low melting point material to enable soldering of a multilayer ceramic electronic component. The first layer may be disposed on the first external electrode 120, and the second layer may be disposed on the first layer. The first layer may include nickel (Ni), and the second layer may include tin (Sn), but the present embodiment is not limited thereto.

The second plating layer 190 covers the second external electrode 130. The second plating layer 190 may include a first layer and a second layer. The first layer may be disposed on the second external electrode 130, and the second layer may be disposed on the first layer. The first layer may include nickel (Ni), and the second layer may include tin (Sn), but the present embodiment is not limited thereto.

The multilayer ceramic electronic component 100 according to the present embodiment may include a coating layer 170 disposed on at least a portion of the outer surface of the ceramic body 110. The coating layer 170 may be disposed on a portion of the outer surface of the ceramic body 110 except for a portion where the first external electrode 120 and the second external electrode 130 are disposed.

The coating layer 170 may include a water-repellent coating agent to prevent the plating solution from permeating through a portion in which the density of the external electrode is reduced or a lifted portion between the external electrode and the ceramic body during the process of forming the plating layer on the external electrode. Additionally, the coating layer 170 may contain at least one of a heat stabilizer and an antioxidant to prevent the coating layer from being destroyed due to the formation of free radicals from the water-repellent coating agent by heat energy.

Here, the heat stabilizer can remove free radicals generated from the water-repellent coating agent, and the antioxidant can decompose the free radical forming factor. Referring to reaction formula 1, when heat energy is applied to the water-repellent coating agent component composed of molecular formula R·H, free radicals of ROO· are formed, and the heat stabilizer reacts with free radicals of ROO· to remove free radicals.

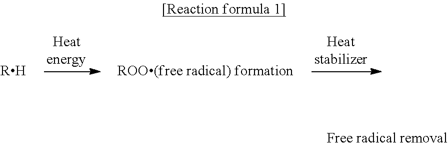

Here, the free radical of ROO· combines with R. H to form ROOH, a free radical forming factor, and as shown in Reaction formula 2, the antioxidant reacts with ROOH to decompose ROOH into ROH. Therefore, it is possible to prevent ROOH from being decomposed into RO· and ·OH to form free radicals.

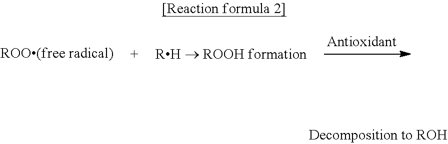

In reaction formulas 1 and 2, R may be a hydrocarbon-based moiety, for example, a hydrocarbon-based moiety in which at least one hydrogen atom is substituted with fluorine (F).

The coating layer 170 may be formed of one layer including at least one of the heat stabilizer and the antioxidant, and the water-repellent coating agent, or may be formed of multiple layers each including the heat stabilizer, the antioxidant, and the water-repellent coating agent. Various modifications may be made, for example, the coating layer 170 may be formed of one layer including all of the water-repellent coating agent, the heat stabilizer, the antioxidant, or may further include a layer including the water-repellent coating agent. The coating layer 170 may be formed of a first layer including the heat stabilizer, a second layer including the antioxidant, and a third layer including the water-repellent coating agent. The coating layer 170 may be formed of a first layer including the antioxidant, a second layer including the heat stabilizer, and a third layer including the water-repellent coating agent. Furthermore, the coating layer 170 may be formed of a first layer including the heat stabilizer, and a second layer including the water-repellent coating agent, or may be formed of a first layer including all of the water-repellent coating agent, the heat stabilizer, and the antioxidant, a second layer including the heat stabilizer, a third layer including the antioxidant, and fourth layer including the water-repellent coating agent.

The water-repellent coating agent may include fluorine-based compound, and may include, for example, at least one of silane-fluorine-based compound, perfluoropolyether (PFPE), polytetrafluoroethylene (PTFE), fluorinatedethylene propylene (FEP), and polyvinylfluoride (PVF).

The heat stabilizer removes free radicals generated from the water-repellent coating agent and may include at least one of a benzotriazole-based compound, a sebacate-based compound, and a formamidine-based compound. For example, the benzotriazole-based compound may include hydroxyphenylbenzotriazole, the sebacate-based compound may include at least one of bis-(1,2,2,6,6-pentamethyl-4-piperidyl) sebacate, and bis-(1-octyl-2,2,6,6-tetramethyl-4-piperidyl) sebacate, and formamidine-based compound may include at least one of N-(4-alkoxycarbonylphenyl)-N′-alkyl-N′-phenylformamidine, N-(4-methoxycarbonylphenyl)-N′-methyl-N′-phenylform amidine, N-(4-ethoxycarbonylphenyl)-N′-methyl-N′-phenylformamidine, and N-(4-ethoxycarbonylphenyl)-N′-ethyl-N′-phenylformamidine.

The antioxidant decomposes the free radical forming factor and may include at least one of a phenol-based compound and a phosphorus-based compound. For example, the phenol-based compound may include at least one of methylhydrocinnamate, benzenepropionic acid, tetrakis [methylene-3 (3′5′-di-tert-butyl-4′-hydroxyphenyl) propionate]methane, and triethyleneglycol bis(3-tert-butyl-4-hydroxy-5-methylphenyl) propionate, and the phosphorus-based compound may include phosphite-based compound.

At least one of the first external electrode 120, the second external electrode 130, and the ceramic body 110 may include the above-described components of the coating layer 170. In particular, the components of the coating layer 170 may be filled in a crack portion of the surfaces of the first external electrode 120 and the second external electrode 130 or the surface of the ceramic body 110, or the lifted portion between the ceramic body 110, and the first external electrode 120 and the second external electrode 130 to prevent moisture from permeating into the ceramic body 110.

In the present embodiment, the coating layer 170 includes a first layer 171 including the heat stabilizer, the antioxidant, and the water-repellent coating agent, and a second layer 173 disposed on the first layer 171 and including the water-repellent coating agent.

The ceramic body 110, the first external electrode 120, and the second external electrode 130 may include a component 171a of the first layer 171. In particular, the component 171a in which the heat stabilizer, the antioxidant, and the water-repellent coating agent are mixed may be filled in a crack portion of the surfaces of the first external electrode 120 and the second external electrode 130 or the surface of the ceramic body 110, or a boundary portion between the ceramic body 110, and the first external electrode 120 and the second external electrode 130.

According to the present embodiment, since the first layer 171 includes all of the heat stabilizer, the antioxidant, and the water-repellent coating agent, free radicals formed by heat energy may be removed, and deterioration of the first layer 171 may be suppressed by decomposing the free radical forming factor. In addition, since the second layer 173 is included on the first layer 171, the water-repellent performance of the coating layer 170 can be further improved.

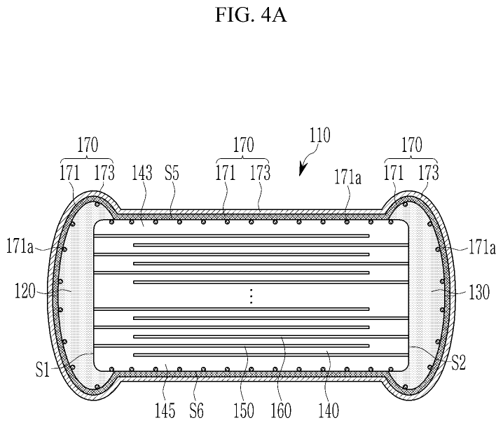

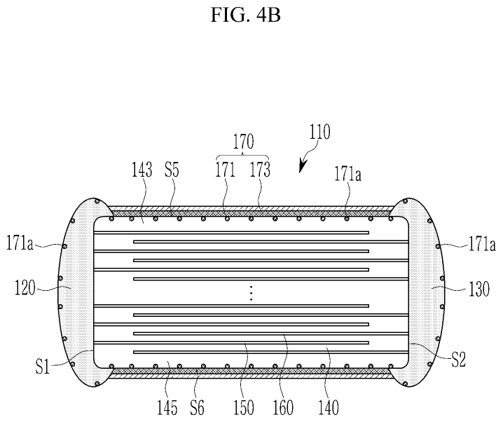

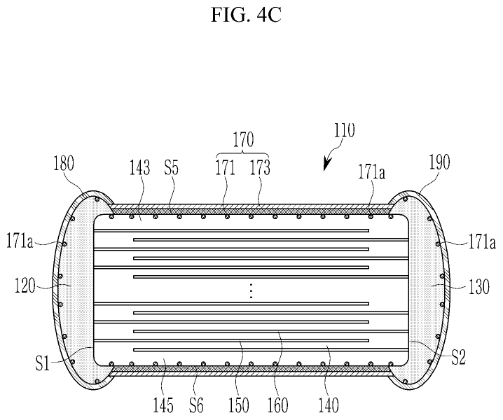

Hereinafter, a process of manufacturing a multilayer ceramic electronic component according to an embodiment will be described in detail with reference to FIGS. 4A to 4C. FIGS. 4A to 4C are cross-sectional views of manufacturing steps of a multilayer ceramic electronic component according to an embodiment.

Referring to FIG. 4A, the first layer 171 including the heat stabilizer, the antioxidant, and the water-repellent coating agent and the second layer 173 including the water-repellent coating agent may be formed on outer a surface of the ceramic body 110 and outer surfaces of the first external electrode 120 and the second external electrode 130. Here, the component 171a of the first layer 171 may be filled in the crack portion of the surfaces of the first external electrode 120 and the second external electrode 130 or the surface of the ceramic body 110, or the boundary portion between the ceramic body 110, and the first external electrode 120 and the second external electrode 130.

Specifically, the first layer 171 may be formed by applying and drying a slurry mixed with the heat stabilizer, the antioxidant, and the water-repellent coating agent to the outer surface of the ceramic body 110, and the outer surfaces of the first external electrode 120 and the second external electrode 130. The heat stabilizer may be mixed in an amount of 1 part by weight to 10 parts by weight per 100 parts by weight of the water-repellent coating agent, and the antioxidant may be mixed in an amount of 1 part by weight to 10 parts by weight per 100 parts by weight of the water-repellent coating agent.

Referring to FIG. 4B, the coating layer 170 formed on the outer surfaces of the first external electrode 120 and the second external electrode 130 is removed through dry or wet polishing. At this time, even if the coating layer 170 is removed, the components 171a of the first layer 171 filled on the surfaces of the first external electrode 120 and the second external electrode 130 may remain. In this case, ROH may remain as the component 171a of the first layer 171, R may be a hydrocarbon-based moiety, for example, a hydrocarbon-based moiety in which at least one hydrogen atom is substituted with fluorine (F). Therefore, the surfaces of the first external electrode 120 and the second external electrode 130 may be completely sealed.

Referring to FIG. 4C, the first plating layer 180 and the second plating layer 190 are formed on outer surfaces of the first external electrode 120 and the second external electrode 130 from which the coating layer 170 is removed. Since the ceramic body 110, the first external electrode 120, and the second external electrode 130 are sealed by the coating layer 170, permeation of the plating solution during the plating process may be suppressed.

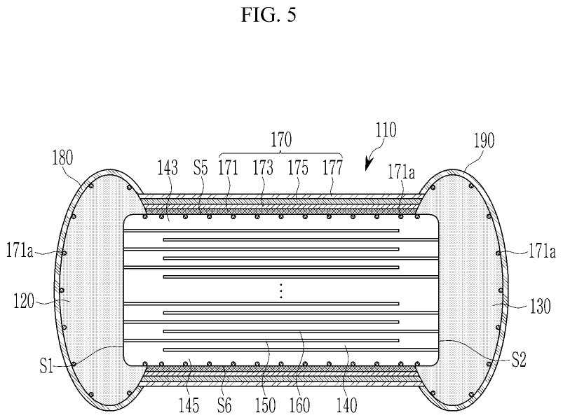

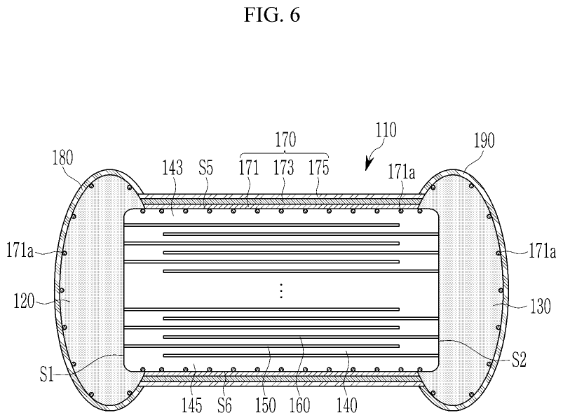

Hereinafter, the multilayer ceramic electronic component according to various embodiments will be described in more detail with reference to FIGS. 5 and 6. FIG. 5 is a cross-sectional view showing a multilayer ceramic electronic component according to another embodiment, and FIG. 6 is a cross-sectional view showing a multilayer ceramic electronic component according to still another embodiment.

The multilayer ceramic electronic components shown in FIG. 5 and FIG. 6 have substantially the same configuration as those of the embodiment described with reference to FIG. 1 to FIG. 3. Hereinafter, different configurations will be described, and the same configurations will be used by the same reference numerals, and configurations that are not separately described may be configured in the same manner as the embodiments shown in FIGS. 1 to 3.

Referring to FIG. 5, a multilayer ceramic electronic component according to the present embodiment includes the coating layer 170 disposed on at least a portion of the outer surface of the ceramic body 110. The coating layer 170 may be disposed on a portion of the outer surface of the ceramic body 110 except for a portion where the first external electrode 120 and the second external electrode 130 are disposed.

The coating layer 170 includes the first layer 171 including the heat stabilizer, the antioxidant, and the water-repellent coating agent, the second layer 173 disposed on the first layer 171 and including the heat stabilizer, a third layer 175 disposed on the second layer 173 and including the antioxidant, and a fourth layer 177 disposed on the third layer 175 and including the water-repellent coating layer.

The ceramic body 110, the first external electrode 120, and the second external electrode 130 may include a component 171a of the first layer 171. In particular, the component 171a in which the heat stabilizer, the antioxidant, and the water-repellent coating agent are mixed may be filled in a crack portion of the surfaces of the first external electrode 120 and the second external electrode 130 or the surface of the ceramic body 110, or a boundary portion between the ceramic body 110, and the first external electrode 120 and the second external electrode 130.

Referring to FIG. 6, the multilayer ceramic electronic component according to the present embodiment includes the coating layer 170 disposed on at least a portion of the outer surface of the ceramic body 110. The coating layer 170 may be disposed on a portion of the outer surface of the ceramic body 110 except for a portion where the first external electrode 120 and the second external electrode 130 are disposed.

The coating layer 170 includes the first layer 171 including the heat stabilizer, the second layer 173 disposed on the first layer 171 and including antioxidant, and the third layer 175 disposed on the second layer 173 and including the water-repellent coating agent.

The ceramic body 110, the first external electrode 120, and the second external electrode 130 may include a component 171a of the first layer 171. In particular, the component 171a of the heat stabilizer may be filled in a crack portion of the surfaces of the first external electrode 120 and the second external electrode 130 or the surface of the ceramic body 110, or a boundary portion between the ceramic body 110, and the first external electrode 120 and the second external electrode 130.

### Experimental Example 1

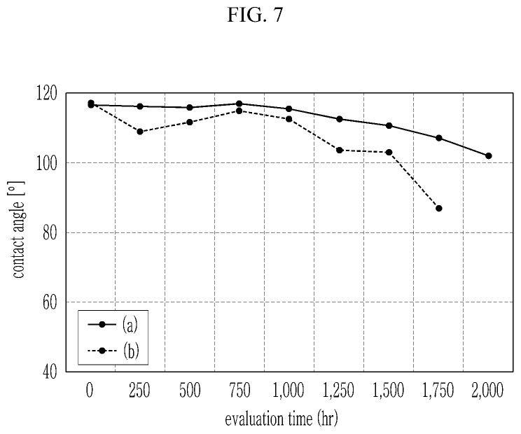

Hereinafter, moisture resistance reliability of an embodiment and a comparative example will be described with reference to FIG. 7.

FIG. 7 is a graph of water-repellent coating performance of multilayer ceramic electronic components according to an embodiment and a comparative example. In FIG. 7, a solid line (a) represents the embodiment, and a dotted line (b) represents the comparative Example.

In FIG. 7, the embodiment is the multilayer ceramic electronic component having a structure in which the coating layer disposed on at least a portion of an outer surface of the ceramic body is illustrated in FIGS. 1 to 3. That is, the coating layer has a structure including the first layer including the heat stabilizer, the antioxidant, and the water-repellent coating agent, and the second layer disposed on the first layer and including a water-repellent coating agent. Meanwhile, in the comparative example, the coating layer contains only the water-repellent coating agent.

Specifically, a slurry obtained by mixing the heat stabilizer, the antioxidant, and the water-repellent coating agent was applied and dried to the outer surface of the ceramic body and the outer surfaces of the first and second external electrodes to form the first layer, and a slurry containing the water-repellent coating agent was applied and dried on the formed first layer to form the second layer. Here, perfluoropolyether (PFPE) was used as the silane-fluorine-based compound as the water-repellent coating agent, hydroxyphenylbenzotriazole was used as the heat stabilizer, and benzenepropionic acid was used as the antioxidant. At this time, the heat stabilizer was used in an amount of 10 parts by weight per 100 parts by weight of the water-repellent coating agent, and the antioxidant was used in an amount of 10 parts by weight per 100 parts by weight of the water-repellent coating agent.

A contact angle measurement method was used to measure the performance of the water-repellent coating, and in particular, a static contact angle measurement method, sessile drop method, was used. Specifically, the multilayer ceramic electronic component chip was exposed for a certain period of time, such as 250, 500, 750, and 1000 hours in an 85° C., 85% RH (relative humidity) environment, and liquid droplets were dropped on the chip surface, and the contact angle generated at this time was measured using an optical instrument.

Referring to FIG. 7, in the case of the embodiment, solid line (a), the contact angle showed good water-repellent performance of 100 degrees or more even after 2000 hours, but in the case of the comparative example, dotted line (b), the contact angle rapidly decreases after 1500 hours and drops below 90 degrees. This is because the water-repellent coating agent constituting the coating layer of the comparative example forms a free radicals by heat energy, thereby destroying the coating layer. Therefore, in the case of the embodiment, it can be seen that moisture resistance is significantly improved compared to the comparative example.

### Experimental Example 2

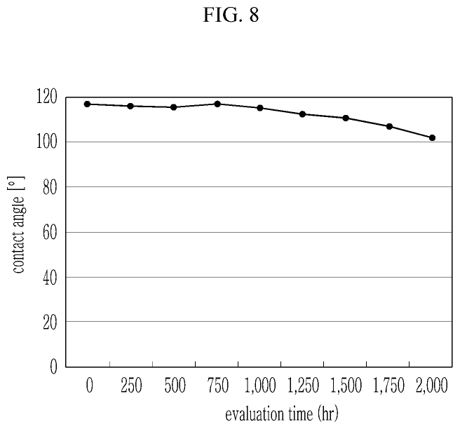

Hereinafter, moisture resistance reliability of the multilayer ceramic electronic component according to another embodiment will be described with reference to FIG. 8.

FIG. 8 is a graph of water-repellent coating performance of a multilayer ceramic electronic component according to another embodiment.

In FIG. 8, the multilayer ceramic electronic component according to another embodiment is the multilayer ceramic electronic component in which the coating layer disposed on at least a portion of an outer surface of the ceramic body has a structure as shown in FIG. 5. That is, the coating layer includes the first layer including the heat stabilizer, antioxidant, and the water-repellent coating agent, the second layer disposed on the first layer and including the heat stabilizer, the third layer disposed on the second layer and including antioxidant, and the fourth layer disposed on the third layer and including the water-repellent coating agent.

Specifically, a slurry obtained by mixing the heat stabilizer, the antioxidant, and the water-repellent coating agent was applied and dried to the outer surface of the ceramic body and the outer surfaces of the first and second external electrodes to form the first layer, a slurry containing the heat stabilizer was applied and dried on the formed first layer to form the second layer, a slurry containing the antioxidant was applied and dried on the formed second layer to form the third layer, and a slurry containing the water-repellent coating agent was applied and dried on the formed third layer to form the fourth layer. Here, perfluoropolyether (PFPE) was used as the silane-fluorine-based compound as the water-repellent coating agent, hydroxyphenylbenzotriazole was used as the heat stabilizer, and benzenepropionic acid as phenol-based compound was used as the antioxidant. At this time, the heat stabilizer was used in an amount of 10 parts by weight per 100 parts by weight of the water-repellent coating agent, and the antioxidant was used in an amount of 10 parts by weight per 100 parts by weight of the water-repellent coating agent.

A contact angle measurement method was used to measure the performance of the water-repellent coating, and in particular, a static contact angle measurement method, sessile drop method, was used. Specifically, the multilayer ceramic electronic component chip was exposed for a certain period of time, such as 250, 500, 750, and 1000 hours in an 85° C., 85% RH (relative humidity) environment, and liquid droplets were dropped on the chip surface, and the contact angle generated at this time was measured using an optical instrument.

Referring to FIG. 8, it may be seen that in the case of the present embodiment, the contact angle shows a good water-repellent performance of 100 degrees or more even after 2000 hours. Therefore, in the case of the present embodiment, it may be seen that the moisture resistance is remarkably improved.

### Experimental Example 3

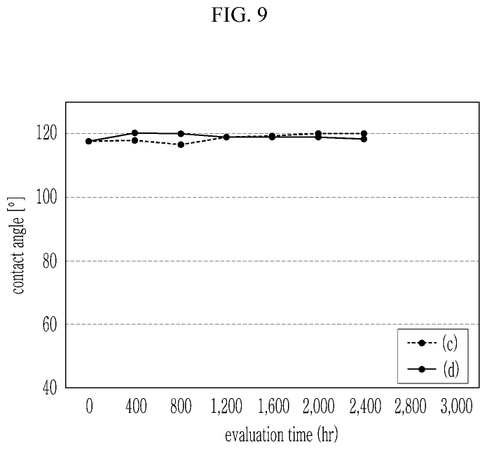

Hereinafter, moisture resistance reliability of the multilayer ceramic electronic component according to various embodiments will be described with reference to FIG. 9.

FIG. 9 is a graph of water-repellent coating performance of a multilayer ceramic electronic component according to yet another embodiment. In FIG. 9, a dotted line (c) represents a embodiment 1, and a solid line (d) represents a embodiment 2.

In FIG. 9, the multilayer ceramic electronic component according to the embodiment 1 is the multilayer ceramic electronic component in which the coating layer disposed on at least a portion of the outer surface of the ceramic body has a structure as shown in FIG. 6. That is, the coating layer includes the first layer including the heat stabilizer, the second layer disposed on the first layer and including the antioxidant, and the third layer disposed on the second layer and including water-repellent coating agent. Meanwhile, according to the embodiment 2 of the multilayer ceramic electronic component, the coating layer is disposed on at least a portion of the outer surface of the ceramic body, and includes the first layer including the antioxidant, the second layer disposed on the first layer and including the heat stabilizer, and the third layer disposed on the second layer and including the water-repellent coating agent.

Specifically, in the case of the embodiment 1, a slurry containing the heat stabilizer was applied and dried on the outer surface of the ceramic main body, the first external electrode, and the second external electrode to form the first layer, a slurry containing the antioxidant was applied and dried on the formed first layer to form the second layer, and a slurry containing the water-repellent coating agent was applied and dried on the formed second layer to form the third layer. In addition, in the case of the embodiment 2, a slurry containing the antioxidant was applied and dried on the outer surface of the ceramic body and the outer surfaces of the first and second external electrodes to form the first layer, a slurry containing the heat stabilizer was applied and dried on the formed first layer to form the second layer, and a slurry containing the water-repellent coating agent was applied and dried on the formed second layer to form the third layer. Here, perfluoropolyether (PFPE) was used as the silane-fluorine-based compound as the water-repellent coating agent, hydroxyphenylbenzotriazole was used as the heat stabilizer, and benzenepropionic acid as phenol-based compound was used as the antioxidant

At this time, the heat stabilizer was used in an amount of 10 parts by weight per 100 parts by weight of the water-repellent coating agent, and the antioxidant was used in an amount of 10 parts by weight per 100 parts by weight of the water-repellent coating agent.

A contact angle measurement method was used to measure the performance of the water-repellent coating, and in particular, a static contact angle measurement method, sessile drop method, was used. Specifically, the multilayer ceramic electronic component chip was exposed for a certain period of time, such as 250, 500, 750, and 1000 hours in an 85° C., 85% RH (relative humidity) environment, and liquid droplets were dropped on the chip surface, and the contact angle generated at this time was measured using an optical instrument.

Referring to FIG. 9, it can be seen that the embodiment 1, dotted line (c), showed good water-repellent performance at 120 degrees or more even after 2,400 hours, and the embodiment 2, solid line (d), showed good water-repellent performance at almost 120 degrees even after 2,400 hours. Therefore, in the cases of the embodiment 1 and 2, it may be seen that the moisture resistance is significantly improved.

While embodiments of the present disclosure have been described above, the present disclosure is not limited thereto, and it is possible to perform various modifications within the scope of the claims, the detailed description, and the accompanying drawings, and it is natural that these modifications also fall within the scope of the present disclosure.

What is claimed is:

1. A multilayer ceramic electronic component, comprising:
a ceramic body comprising a plurality of dielectric layers, and a plurality of internal electrodes disposed with the dielectric layers interposed therebetween;
an external electrode disposed outside the ceramic body; and
a coating layer disposed on at least a portion of an outer surface of the ceramic body,
wherein the coating layer comprises
a water-repellent coating agent, and
at least one of a heat stabilizer removing a free radical generated from the water-repellent coating agent and an antioxidant breaking down a free radical forming factor.

2. The multilayer ceramic electronic component of claim 1, wherein:
the coating layer comprises a first layer comprising the heat stabilizer, the antioxidant, and the water-repellent coating agent, and a second layer disposed on the first layer and comprising the water-repellent coating agent.

3. The multilayer ceramic electronic component of claim 1, wherein:
the coating layer comprises
a first layer comprising the heat stabilizer, the antioxidant, and the water-repellent coating agent,
a second layer disposed on the first layer and comprising the heat stabilizer,
a third layer disposed on the second layer and comprising the antioxidant, and
a fourth layer disposed on the third layer and comprising the water-repellent coating agent.

4. The multilayer ceramic electronic component of claim 1, wherein:
the coating layer comprises
a first layer comprising the heat stabilizer,
a second layer disposed on the first layer and comprising the antioxidant, and
a third layer disposed on the second layer and comprising the water-repellent coating agent.

5. The multilayer ceramic electronic component of claim 1, wherein:
the coating layer comprises
a first layer comprising the antioxidant,
a second layer disposed on the first layer and comprising the heat stabilizer, and
a third layer disposed on the second layer and comprising the water-repellent coating agent.

6. The multilayer ceramic electronic component of claim 1, wherein:
the coating layer comprises
a first layer comprising the heat stabilizer, and
a second layer disposed on the first layer and comprising the water-repellent coating agent.

7. The multilayer ceramic electronic component of claim 1, wherein:
the coating layer is disposed on a portion of the outer surface of the ceramic body except for a portion where the external electrode is disposed.

8. The multilayer ceramic electronic component of claim 1, wherein:
at least one of the ceramic body and the external electrode comprises a component of the coating layer.

9. The multilayer ceramic electronic component of claim 1, wherein:
the water-repellent coating agent comprises a fluorine-based compound selected from a group consisting of a silane-fluorine-based compound, perfluoropolyether (PFPE), polytetrafluoroethylene (PTFE), fluorinated ethylene propylene (FEP), and polyvinyl fluoride (PVF).

10. The multilayer ceramic electronic component of claim 1, wherein:
the heat stabilizer comprises at least one compound selected from a group consisting of a benzotriazole-based compound comprising hydroxyphenyl benzotriazole, sebacate-based compound comprising at least one of bis-(1,2,2,6,6-pentamethyl-4-piperidyl) sebacate, and bis-(1-octyl-2,2,6,6-tetramethyl-4-piperidyl) sebacate, and formamidine-based compound comprising at least one of N-(4-alkoxy carbonyl phenyl)-N′-alkyl-N′-phenylformamidine, N-(4-methoxycarbonyl phenyl)-N′-methyl-N′-phenylformamidine, N-(4-ethoxycarbonyl phenyl)-N′-methyl-N′-phenylformamidine, and N-(4-ethoxycarbonyl phenyl)-N′-ethyl-N′-phenyl formamidine.

11. The multilayer ceramic electronic component of claim 1, wherein:
the antioxidant comprises at least one compound selected from a group consisting of a phosphorus-based compound comprising a phosphite-based compound, and a phenol-based compound comprising at least one of methyl hydrocinnamate, benzenepropionic acid, tetrakis [methylene-3 (3′5′-di-tert-butyl-4′-hydroxyphenyl) propionate]methane, and triethylene glycol bis(3-tert-butyl-4-hydroxy-5-methylphenyl) propionate.

12. A multilayer ceramic electronic component, comprising:
a ceramic body comprising a plurality of dielectric layers, and a plurality of internal electrodes disposed with the dielectric layers interposed therebetween;
an external electrode disposed outside the ceramic body; and
a coating layer disposed on at least a portion of an outer surface of the ceramic body,
wherein the coating layer comprises
a fluorine-based compound, and
at least one compound selected from a group consisting of a benzotriazole-based compound, a sebacate-based compound, a formamidine-based compound, a phenol-based compound, and a phosphorus-based compound.

13. The multilayer ceramic electronic component of claim 12, wherein:
the coating layer comprises
a first layer comprising at least one compound selected from the group consisting of the benzotriazole-based compound, the sebacate-based compound, and the formamidine-based compound, at least one compound selected from the group consisting of the phenol-based compound and the phosphorus-based compound, and the fluorine-based compound, and
a second layer disposed on the first layer and comprising the fluorine-based compound.

14. The multilayer ceramic electronic component of claim 12, wherein:
the coating layer comprises
a first layer comprising at least one compound selected from the group consisting of the benzotriazole-based compound, the sebacate-based compound, and the formamidine-based compound, at least one compound selected from the group consisting of the phenol-based compound and the phosphorus-based compound, and the fluorine-based compound,
a second layer disposed on the first layer and comprising at least one compound selected from the group consisting of the benzotriazole-based compound, the sebacate-based compound, and the formamidine-based compound,
a third layer disposed on the second layer and comprising at least one compound selected from the group consisting of the phenol-based compound, and the phosphorus-based compound, and
a fourth layer disposed on the third layer and comprising the fluorine-based compound.

15. The multilayer ceramic electronic component of claim 12, wherein:
the coating layer comprises
a first layer comprising at least one compound selected from the group consisting of the benzotriazole-based compound, the sebacate-based compound, and the formamidine-based compound,
a second layer disposed on the first layer and comprising at least one compound selected from the group consisting of the phenol-based compound, and the phosphorus-based compound, and
a third layer disposed on the second layer and comprising the fluorine-based compound.

16. The multilayer ceramic electronic component of claim 12, wherein:
the coating layer comprises,
a first layer comprising at least one compound selected from the group consisting of the phenol-based compound, and the phosphorus-based compound,
a second layer disposed on the first layer and comprising at least one compound selected from the group consisting of the benzotriazole-based compound, the sebacate-based compound, and the formamidine-based compound, and
a third layer disposed on the second layer and comprising the fluorine-based compound.

17. The multilayer ceramic electronic component of claim 12, wherein:
the coating layer comprises
a first layer comprising at least one compound selected from the group consisting of the benzotriazole-based compound, the sebacate-based compound, and the formamidine-based compound, and
a second layer disposed on the first layer and comprising the fluorine-based compound.

18. The multilayer ceramic electronic component of claim 12, wherein:
the benzotriazole-based compound comprises hydroxyphenyl benzotriazole,
the sebacate-based compound comprises at least one of bis-(1,2,2,6,6-pentamethyl-4-piperidyl) sebacate, and bis-(1-octyl-2,2,6,6-tetramethyl-4-piperidyl) sebacate,
the formamidine-based compound comprises at least one of N-(4-alkoxycarbonyl phenyl)-N′-alkyl-N′-phenylformamidine, N-(4-methoxycarbonyl phenyl)-N′-methyl-N′-phenylformamidine, N-(4-ethoxycarbonylphenyl)-N′-methyl-N′-phenylformamidine, and N-(4-ethoxycarbonyl phenyl)-N′-ethyl-N′-phenyl formamidine, and
the fluorine-based compound comprises at least one of silane-fluorine-based compound, perfluoropolyether (PFPE), polytetrafluoroethylene (PTFE), fluorinated ethylene propylene (FEP), and polyvinyl fluoride (PVF).

19. The multilayer ceramic electronic component of claim 12, wherein:
the phenol-based compound comprises at least one of methyl hydrocinnamate, benzenepropionic acid, tetrakis [methylene-3 (3′5′-di-tert-butyl-4′-hydroxyphenyl) propionate]methane, and triethylene glycol bis(3-tert-butyl-4-hydroxy-5-methylphenyl) propionate, and
the phosphorus-based compound comprises phosphite-based compound.

20. The multilayer ceramic electronic component of claim 12, wherein:
at least one of the ceramic body and the external electrode comprises a component of the coating layer.

21. The multilayer ceramic electronic component of claim 1,
wherein the heat stabilizer is present in an amount of 1 to 10 parts by weight per 100 parts by weight of the water-repellent coating agent,
and the antioxidant is present in an amount of 1 to 10 parts by weight per 100 parts by weight of the water-repellent coating agent.
